(19) United States
(12) Patent Application Publication
(10) Pub. No.: US 2016/0328627 A1
(43) Pub. Date: Nov. 10, 2016

(54) IMAGING DEVICE, RECORDING DEVICE, AND MOVING IMAGE OUTPUT CONTROL DEVICE

(71) Applicant: PANASONIC INTELLECTUAL PROPERTY MANAGEMENT CO., LTD., Osaka-shi (JP)

(72) Inventors: Hirofumi FUJII, Kanagawa (JP); Kazuhiko IWAI, Kanagawa (JP); Tetsurou KAKIZAWA, Kanagawa (JP); Kosuke HOSOI, Fukuoka (JP); Marie KUWAHARA, Fukuoka (JP); Kazuma YOSHIDA, Saitama (JP)

(73) Assignee: PANASONIC INTELLECTUAL PROPERTY MANAGEMENT CO., LTD., Osaka (JP)

(21) Appl. No.: 15/027,540

(22) PCT Filed: Oct. 27, 2015
(86) PCT No.: PCT/JP2015/005372

§ 371 Date: Apr. 6, 2016

(30) Foreign Application Priority Data
Nov. 26, 2014 (JP) 2014-238680

(51) Int. Cl. G06K 9/48; H04N 7/18; H04N 5/232; G06F 21/31; G06T 11/60; G06K 9/46; H04N 5/262; G06K 9/00; G06T 7/00

(52) U.S. Cl. CPC G06K 9/48; G06K 9/00369; H04N 7/18; H04N 5/23245; G06T 7/0081; G06T 11/60; G06K 9/4604; G06K 9/00711; H04N 5/2621; G06F 21/31; G06T 2207/10016; G06T 2207/30196; G06T 2207/30232

(57) ABSTRACT

Provided is an imaging device including a moving image processor that performs a masking process of changing the inside of contours of a person to a mask image on a moving image resulting from imaging a monitored area, a moving image outputter that outputs a masking processed moving image on which the masking process is performed in a first output mode and outputs an unprocessed moving image on which the masking process is not performed in a second output mode, and a controller that switches the output mode of the moving image outputter according to an instruction of a user, in which the controller performs output mode initialization that sets the output mode to the first output mode at a booting of the device.

### TECHNICAL FIELD

The present invention relates to an imaging device that images a monitored area and outputs a moving image thereof to a browsing apparatus, a recording device that stores a moving image output from the imaging device and outputs the moving image to the browsing apparatus, and a moving image output control device that is connected to the imaging device and controls moving image output to the browsing apparatus.

### BACKGROUND ART

In a store such as a convenience store, there has been widespread use of a monitoring system that monitors the situation in the store with a moving image of a camera installed to image the inside of the store. If the moving image is used for the purpose other than monitoring for crime prevention or protection against disaster, that is, for the purpose of marketing analysis for efficient management of the store, improving a customer service, and the like, it is necessary to protect the privacy of a customer.

In response to the requirement of protecting the privacy of a customer, in the related art, there is known a technology that performs a masking process (concealing process) of changing a region of a person in a moving image imaged by the camera to a specific mask image (refer to PTL 1 and PTL 2). Particularly, in the technology disclosed in PTL 1, a motion of the body of the person is easily recognized by displaying feature points in the mask image. In the technology disclosed in PTL 2, an action of the person is easily recognized from the background by making the mask image transmissive.

### CITATION LIST

### Patent Literature

PTL 1: Japanese Patent Unexamined Publication No. 2013-186838

PTL 2: Japanese Patent No. 5159381

### SUMMARY OF INVENTION

An imaging device of the present invention is an imaging device that images a monitored area and outputs a moving image thereof to a browsing apparatus, the imaging device including a moving image processor that performs a masking process of changing the inside of contours of a person to a mask image on the moving image, a moving image outputter that outputs a masking processed moving image on which the masking process is performed in a first output mode and outputs an unprocessed moving image on which the masking process is not performed in a second output mode, and a controller that switches the output mode of the moving image outputter according to an instruction of a user, in which the controller performs output mode initialization that sets the output mode to the first output mode at a booting of the device.

### BRIEF DESCRIPTION OF DRAWINGS

FIG. 1 is a diagram of an entire configuration of a monitoring system according to a first exemplary embodiment.

FIG. 2 is a plan view of a store illustrating a store layout and a situation of installation of camera 1.

FIG. 3A is a descriptive diagram illustrating a summary of processing performed by camera 1.

FIG. 3B is a descriptive diagram illustrating a summary of processing performed by camera 1.

FIG. 4 is a functional block diagram illustrating a schematic configuration of camera 1 and PC 3.

FIG. 5 is a functional block diagram illustrating processing performed by moving image processor 23.

FIG. 6 is a descriptive diagram illustrating a monitoring screen displayed on monitor 7.

FIG. 7 is a functional block diagram of a main portion related to processing of generating a heat map image.

FIG. 8 is a descriptive diagram illustrating a screen displayed on monitor 7 when an output mode is changed.

FIG. 9 is a flowchart illustrating a moving image output control procedure performed by controller 26 of camera 1.

FIG. 10 is a descriptive diagram illustrating a menu screen displayed on monitor 7 when authentication information and a resumption time are set.

FIG. 11 is a descriptive diagram illustrating an authentication information setting screen displayed on monitor 7.

FIG. 12 is a descriptive diagram illustrating a resumption time setting screen displayed on monitor 7.

FIG. 13 is a functional block diagram illustrating a schematic configuration of camera 101 and recorder 102 in a second exemplary embodiment.

FIG. 14 is a functional block diagram illustrating a schematic configuration of camera 111 and recorder 102 in a third exemplary embodiment.

FIG. 15 is a functional block diagram illustrating a schematic configuration of adapter 121 in a fourth exemplary embodiment.

### DESCRIPTION OF EMBODIMENTS

A problem in the technology of the related art will be briefly described prior to description of exemplary embodiments of the present invention. In recent years, there has been use of a system that employs a network connectable so-called IP camera and a network connectable recorder to which a browsing apparatus such as a PC is connected through a network for browsing of a moving image. Such a system involves the risk of leakage of an unprocessed moving image on which a masking process is not performed and thus requires improvement from the viewpoint of protecting privacy. However, no consideration is made with respect to such a problem of leakage of an unprocessed moving image in the technology of the related art, thereby posing the problem that the risk of leakage of an unprocessed moving image cannot be sufficiently reduced.

In order to resolve the problem, according to a first aspect of the invention, there is provided an imaging device that images a monitored area and outputs a moving image thereof to a browsing apparatus, the imaging device including a moving image processor that performs a masking process of changing the inside of contours of a person to a mask image on the moving image, a moving image outputter that outputs a masking processed moving image on which the masking process is performed in a first output mode and outputs an unprocessed moving image on which the masking process is not performed in a second output mode, and a controller that switches the output mode of the moving image outputter according to an instruction of a user, in which the controller performs output mode initialization that sets the output mode to the first output mode at a booting of the device.

According to this aspect, a state where the masking processed moving image on which the masking process is performed is output is set by output mode initialization performed at the booting of the device. Thus, the risk of leakage of the unprocessed moving image on which the masking process is not performed can be reduced.

According to a second aspect of the invention, the imaging device further includes a user authenticator that retains authentication information related to a user having permission to browse the unprocessed moving image and performs user authentication by comparing input information input by the user in the browsing apparatus with the authentication information, in which the controller performs a control that switches the moving image outputter to the second output mode only if user authentication succeeds in the user authenticator.

According to this aspect, only the user having permission to browse the unprocessed moving image can switch the output mode to the second output mode in which the unprocessed moving image is output, and the output mode is not easily changed to the second output mode. Thus, the risk of leakage of the unprocessed moving image can be further reduced.

According to a third aspect of the invention, the authentication information is a password.

According to this aspect, only a user to whom a password is distributed can switch the output mode to the second output mode in which the unprocessed moving image is output.

According to a fourth aspect of the invention, the authentication information is a set of a user ID and a password.

According to this aspect, only a previously registered user can switch the output mode to the second output mode in which the unprocessed moving image is output.

According to a fifth aspect of the invention, the controller performs a control that restores the moving image outputter to the first output mode if the period of time elapsing from the point in time of a transition into a pause state where moving image output to the browsing apparatus is not performed reaches a predetermined resumption time after the moving image outputter is switched to the second output mode.

According to this aspect, the output mode is restored to the first output mode in which the masking processed moving image is output if a state where a moving image is not browsed by the browsing apparatus continues. Thus, long-term presence of the second output mode in which the unprocessed moving image is output can be avoided, and the risk of leakage of the unprocessed moving image can be further reduced.

According to a sixth aspect of the invention, the imaging device further includes a resumption time setter that sets the resumption time according to a manipulation input of a user inputting an arbitrary period of time.

According to this aspect, a user can freely specify the resumption time.

According to a seventh aspect of the invention, there is provided a recording device that stores a moving image output from an imaging device and outputs the moving image to a browsing apparatus, the recording device including a moving image storage that stores a moving image input from the imaging device, a moving image processor that performs a masking process of changing the inside of contours of a person to a mask image on the moving image stored in the moving image storage, a moving image outputter that outputs a masking processed moving image on which the masking process is performed in a first output mode and outputs an unprocessed moving image on which the masking process is not performed in a second output mode, and a controller that switches the output mode of the moving image outputter according to an instruction of a user, in which the controller performs output mode initialization that sets the output mode to the first output mode at a booting of the device.

According to this aspect, the risk of leakage of the unprocessed moving image on which the masking process is not performed can be reduced as in the first aspect.

According to an eighth aspect of the invention, there is provided a moving image output control device that is connected to an imaging device and controls moving image output to a browsing apparatus, the moving image output control device including a moving image processor that performs a masking process of changing the inside of contours of a person to a mask image on a moving image input from the imaging device, a moving image outputter that outputs a masking processed moving image on which the masking process is performed in a first output mode and outputs an unprocessed moving image on which the masking process is not performed in a second output mode, and a controller that switches the output mode of the moving image outputter according to an instruction of a user, in which the controller performs output mode initialization that sets the output mode to the first output mode at a booting of the device.

According to this aspect, the risk of leakage of the unprocessed moving image on which the masking process is not performed can be reduced as in the first aspect.

Hereinafter, exemplary embodiments of the present invention will be described with reference to the drawings.

### First Exemplary Embodiment

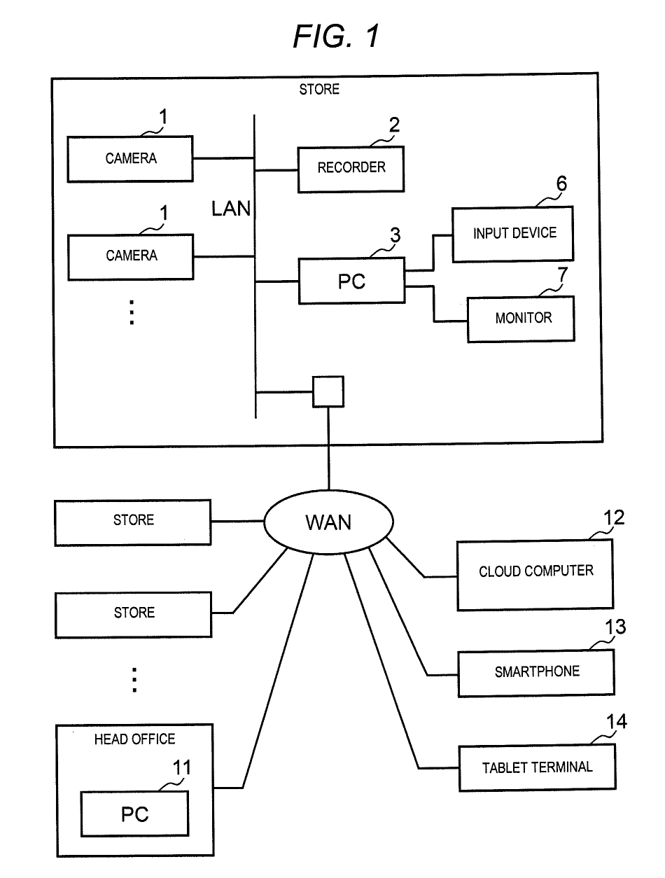

FIG. 1 is a diagram of an entire configuration of a monitoring system according to a first exemplary embodiment. The monitoring system is built for a retail chain store such as a convenience store as a target thereof and includes camera (imaging device) 1, recorder (recording device) 2, and PC (browsing apparatus) 3.

Camera 1 is installed at an appropriate place in a store (facility). The inside of the store is imaged by camera 1. Camera 1 is a network connectable so-called IP camera, and recorder 2 is also configured to be network connectable. Camera 1 and recorder 2 are connected to a LAN installed in the store. A moving image output from camera 1 is stored in recorder 2.

PC 3 is also connected to the LAN. A moving image output from camera 1 and recorder 2 is input into PC 3, and the moving image is displayed on monitor (display device) 7 connected to PC 3. Accordingly, a store side user such as a store manager can browse the moving image of the inside of the store imaged by camera 1 in real time and can browse a past moving image of the inside of the store recorded in recorder 2.

Camera 1, recorder 2, and PC 3 are installed in each of a plurality of stores, and PC 11 is installed in a head office that manages the plurality of stores. PC 11 is connected to camera 1 and recorder 2 of each store through a WAN. Accordingly, a head office side user, for example, a supervisor who provides instructions or suggestions to each store in a region of responsibility, can browse the moving image of the inside of the store imaged by camera 1 in real time and can browse the past moving image of the inside of the store recorded in recorder 2.

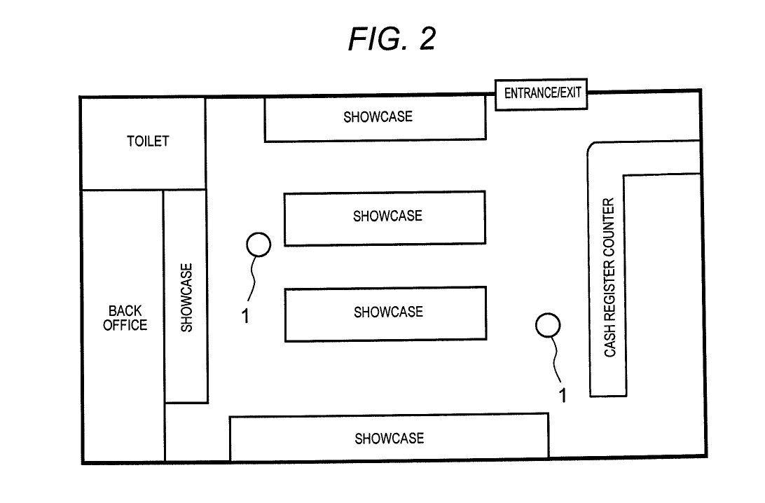

Next, a store layout and a situation of installation of camera 1 will be described. FIG. 2 is a plan view of the store illustrating a store layout and a situation of installation of camera 1.

An entrance/exit, showcases, a cash register counter, and the like are disposed in the store. The showcases are separately installed according to the type of product such as a bento, a PET bottle, and a rice ball. A customer enters the store from the entrance/exit and moves in the store through an aisle between the showcases. If the customer finds a desired product, the customer holds the product and moves toward the cash register counter, completes payment (pays the price) at the cash register counter, and then leaves the store from the entrance/exit.

Camera 1 that images the inside of the store (monitored area) is installed in plural quantities in the store. Camera 1 is installed at an appropriate position on the ceiling inside of the store. Particularly, in the example illustrated in FIG. 2, an omnidirectional camera that has an imaging range of 360 degrees using a fisheye lens is employed as camera 1. Camera 1 can image a person entering or leaving the store from the entrance/exit or a person staying in the store.

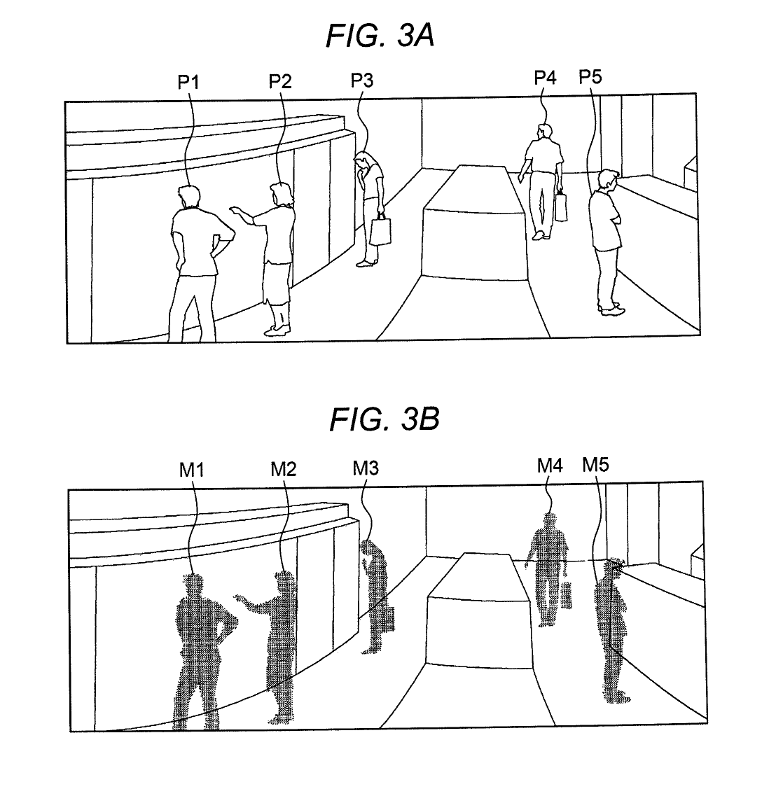

Next, a summary of processing performed by camera 1 illustrated in FIG. 1 will be described. FIG. 3A and FIG. 3B are descriptive diagrams illustrating a summary of processing performed by camera 1.

Browsing the moving image imaged by camera 1 does not pose a problem if performed for the purpose of monitoring for crime prevention or protection against disaster. However, if the moving image is used for the purpose other than monitoring for crime prevention or protection against disaster, that is, for the purpose of marketing analysis for efficient management of the store, improving a customer service, and the like, it is necessary to protect the privacy of the customer.

In the present exemplary embodiment, therefore, performed is a masking process that obtains positional information in an image region of a person appearing in the moving image and changes the inside of the contours of the person to a mask image. Specifically, the image region of the person is detected from the moving image, and information related to the contours of the image region of the person is obtained. Then, a mask image (image in which the inside of the contours of the person is painted out) corresponding to the entire image region of the person is generated on the basis of the information related to the contours, and the mask image is overlaid on a background image to generate a masking processed moving image. In the example illustrated in FIG. 3A, five persons P1 to P5 are imaged in the moving image, and the image regions of persons P1 to P5 are respectively changed to mask images M1 to M5 as illustrated in FIG. 3B.

In the present exemplary embodiment, the unprocessed moving image (video) illustrated in FIG. 3A is displayed in a case of a user who browses the moving image for the purpose of monitoring for crime prevention or protection against disaster. Meanwhile, the masking processed moving image (video) illustrated in FIG. 3B is displayed in a case of a user who browses the moving image for the purpose other than monitoring such as marketing analysis. Even in such a masking processed moving image, the user can recognize the motion of a person by observing the mask image in the moving image.

The mask image is transmissive in the present exemplary embodiment. Thus, the background image is seen therethrough. Display element of the mask image, for example, display elements such as color, shade, a pattern (form), contour lines, and a transmittance, may be set in advance. Alternatively, a user may appropriately change the display elements of the mask image.

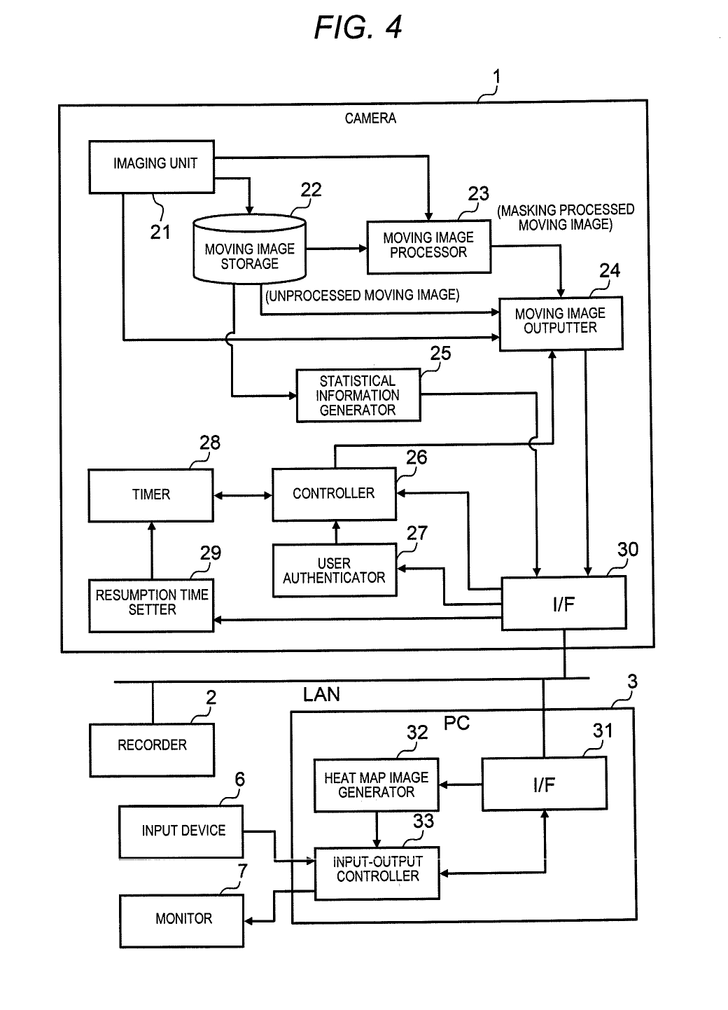

Next, a schematic configuration of camera 1 and PC 3 illustrated in FIG. 1 will be described. FIG. 4 is a functional block diagram illustrating a schematic configuration of camera 1 and PC 3.

Camera 1 includes imaging unit 21, moving image storage 22, moving image processor 23, moving image outputter 24, statistical information generator 25, controller 26, user authenticator 27, timer 28, resumption time setter 29, and interface 30.

Imaging unit 21 is configured of an imaging element, a controller circuit thereof, and the like and outputs a moving image in which the monitored area is imaged. The moving image output from imaging unit 21 is stored in moving image storage 22.

Moving image storage 22 is configured of a memory device such as a memory card, a hard disk drive, and a solid state drive. Since moving image storage 22 is incorporated into camera 1, a memory device of a comparatively small capacity is employed as moving image storage 22, and the most recent moving image is stored within the range of the memory capacity.

In moving image processor 23, the masking process of changing the inside of the contours of a person to the mask image is performed on a moving image. Processing performed by moving image processor 23 will be described in detail later.

In moving image outputter 24, performed is processing that outputs either the masking processed moving image on which the masking process is performed in moving image processor 23 or the unprocessed moving image on which the masking process is not performed according to an instruction from controller 26. In the present exemplary embodiment, a state where the masking processed moving image is output will be referred to as a first output mode, and a state where the unprocessed moving image is output will be referred to as a second output mode.

The moving image output from imaging unit 21 is input into moving image processor 23 and moving image outputter 24 in a mode where a current moving image is displayed in real time. Moving image processor 23 and moving image outputter 24 obtain a moving image from moving image storage 22 in a mode where a past moving image is reproduced.

In timer 28, performed is processing that measures the period of time elapsing from the point in time of a transition into a pause state where moving image output is not performed by moving image outputter 24 with no moving image output request from PC 3 and, if the period of elapsed time reaches a predetermined resumption time, outputs a notification stating the reaching of the resumption time to controller 26.

In resumption time setter 29, performed is processing that sets the resumption time used by timer 28. In the present exemplary embodiment, the resumption time is set according to a manipulation input of a user who inputs an arbitrary period of time. Thus, a user can arbitrarily specify the resumption time.

In user authenticator 27, retained is authentication information related to a user who has permission to browse the unprocessed moving image, and performed is user authentication that verifies whether a user who browses a moving image in PC 3 is the user who has permission to browse the unprocessed moving image by comparing input information that is input by the user in PC 3 with the authentication information.

In controller 26, performed is a moving image output control that controls moving image output in moving image outputter 24. Particularly, output mode initialization that sets the output mode to the first output mode where the masking processed moving image is output is performed in controller 26 at the booting of the device. In addition, in controller 26, a control that switches the output mode of moving image outputter 24 is performed according to a user manipulation input in PC 3, and moving image outputter 24 is switched to the second output mode particularly only if user authentication succeeds in user authenticator 27. In addition, in controller 26, a control that restores moving image outputter 24 to the first output mode is performed if a notification from timer 28, that is, the notification stating that the period of time elapsing from the point in time of a transition into the pause state where moving image output to PC 3 is not performed reaches the resumption time, is received after moving image outputter 24 is switched to the second output mode.

An output mode changing switch (not illustrated) operated by user manipulation may be disposed in camera 1, and a user may provide an instruction to switch the output mode with the switch. In this case, controller 26 performs a control that switches the output mode of moving image outputter 24 on the basis of an output signal of the switch.

In statistical information generator 25, performed is processing that generates statistical information related to the situation of a person staying in the monitored area on the basis of the moving image stored in moving image storage 22. The processing performed by statistical information generator 25 will be described in detail later.

Interface 30 performs transmission and reception of information with PC 3, recorder 2, or the like through the LAN.

PC 3 includes interface 31, heat map image generator 32, and input-output controller 33.

Interface 31 performs transmission and reception of information with camera 1, recorder 2, or the like through the LAN.

In heat map image generator 32, performed is processing that generates a heat map image in which the statistical information generated by statistical information generator 25 disposed in camera 1 is visualized.

Input-output controller 33 constitutes a graphical user interface (GUI), displays a screen on monitor 7, and obtains instruction information and input information from a user according to screen manipulation and input manipulation of the user on the screen using input device 6 such as a mouse and a keyboard.

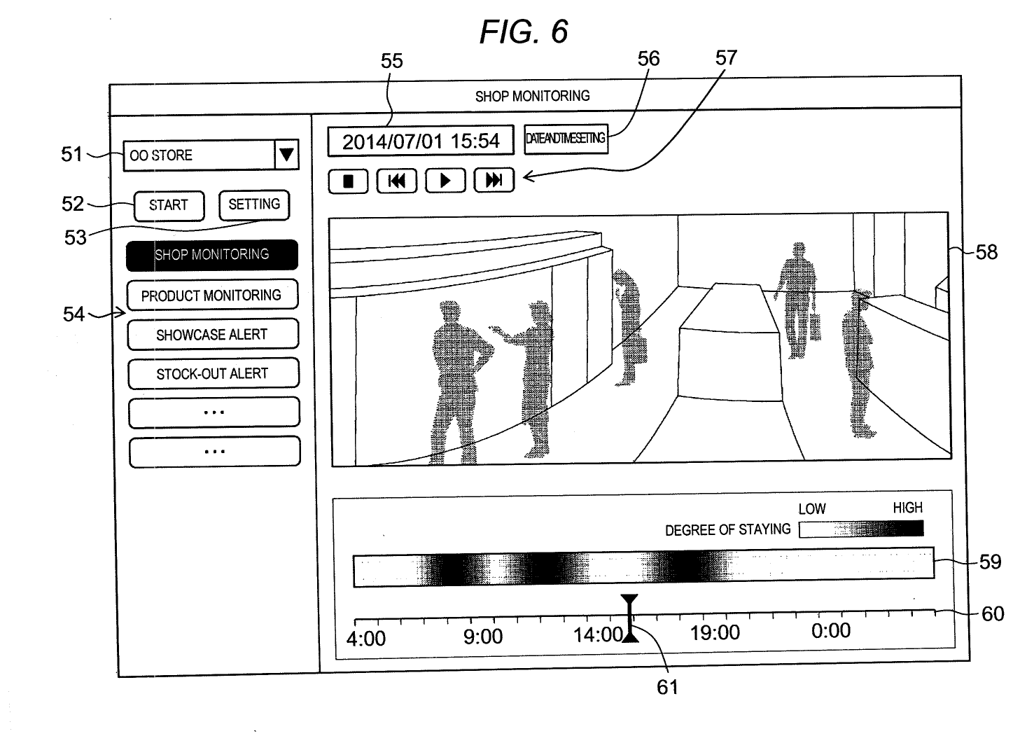

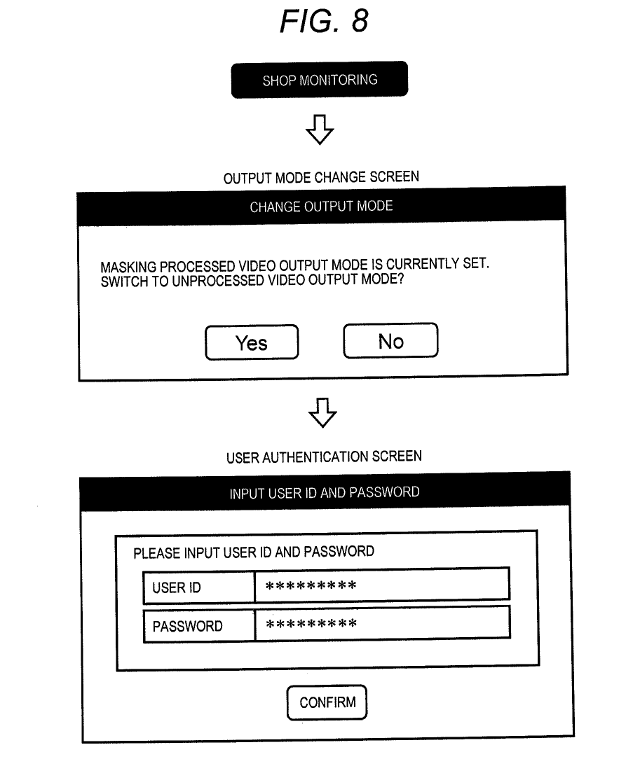

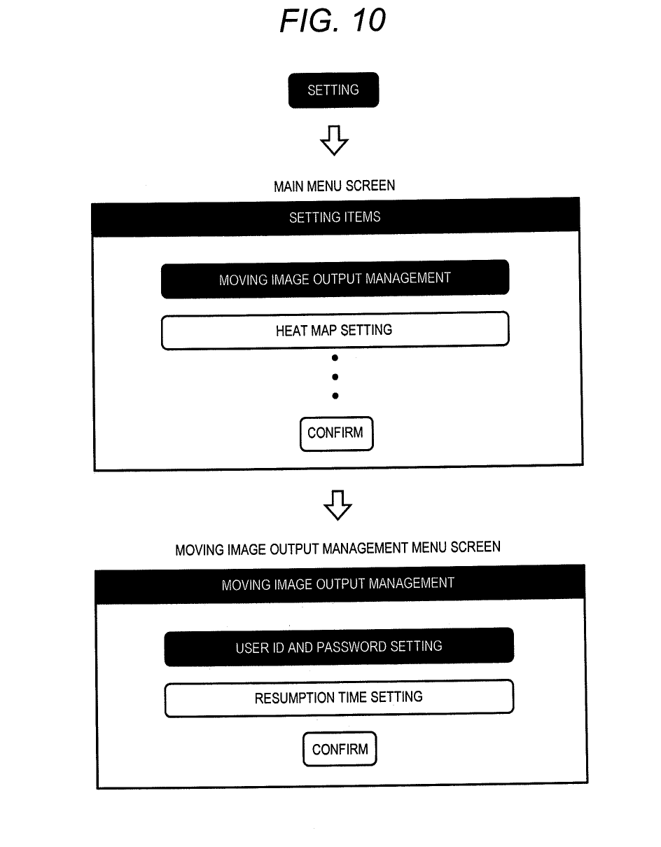

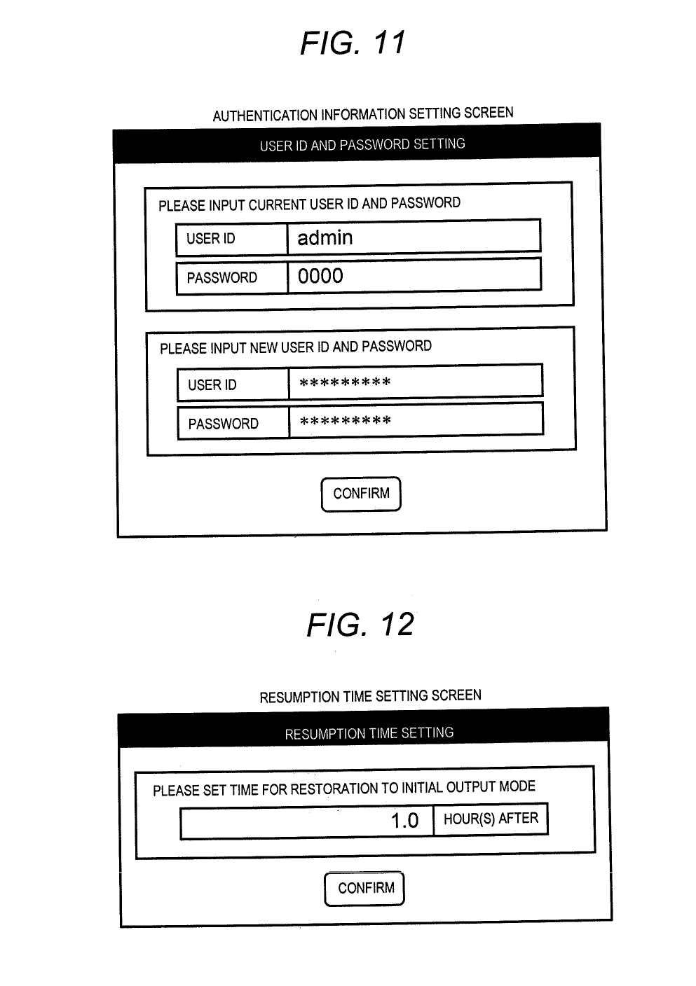

Particularly, in input-output controller 33, performed is processing that generates display information related to a monitoring screen in which the moving image input from camera 1 (masking processed moving image or unprocessed moving image) and the heat map image generated by heat map image generator 32 are displayed. Accordingly, the monitoring screen (refer to FIG. 6) is displayed on monitor 7. In addition, in input-output controller 33, performed is processing that displays an output mode change screen (refer to FIG. 8), a user authentication screen (refer to FIG. 8), a menu screen (refer to FIG. 10), an authentication information setting screen (refer to FIG. 11), and a resumption time setting screen (refer to FIG. 12) on monitor 7.

Each unit of PC 3 illustrated in FIG. 4 is realized by a CPU of PC 3 executing a monitoring (moving image browsing) application program. The program may be configured as a dedicated device that is introduced in advance into PC 3 as an information processing apparatus or may be provided to a user as an application program operating on a versatile OS by either being recorded on an appropriate program recording medium or through a network.

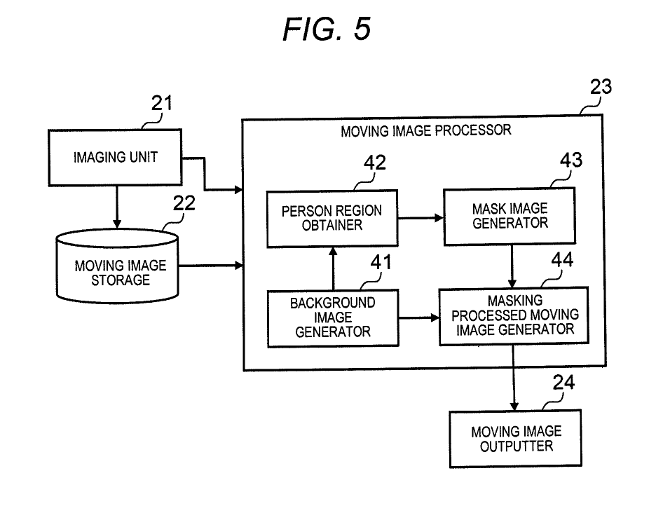

Next, processing performed by moving image processor 23 illustrated in FIG. 4 will be described. FIG. 5 is a functional block diagram representing a part of a configuration of camera 1 and illustrating processing performed by moving image processor 23.

Moving image processor 23 generates the masking processed moving image by performing the masking process of changing the inside of the contours of a person to the mask image on a moving image and includes background image generator 41, person region obtainer 42, mask image generator 43, and masking processed moving image generator 44.

In background image generator 41, performed is processing that generates a background image in which the image of a person (foreground image) is removed from a moving image. In the processing, the background image is generated from a plurality of moving images (frames) in a most recent predetermined learning period, and the background image is sequentially updated according to obtaining of a new moving image (frame). The processing performed by background image generator 41 may use a known technology. While the background image is preferably updated sequentially as described above, a fixed background image that is retained in advance can also be used.

In person region obtainer 42, performed is processing that obtains positional information in an image region of a person existing in a moving image on the basis of the background image generated by background image generator 41. In the processing, the image region of a person is specified from the difference between the moving image at the time of watching (current time in real-time processing) and the background image obtained in the learning period before the time of watching. The processing performed by person region obtainer 42 may use a known technology.

The background image in the present exemplary embodiment includes a so-called “background model”. The background model is built in background image generator 41 from a plurality of images in the learning period. The image region of a person (foreground region) and a background region are divided by comparing the moving image at the time of watching with the background model, and positional information in the image region of a person is obtained in person region obtainer 42.

In mask image generator 43, performed is processing that generates the mask image corresponding to the entire image region of a person on the basis of the positional information in the image region of a person obtained by person region obtainer 42. In the processing, information related to the contours of the image region of a person is generated from the positional information in the image region of a person, and the mask image in which the inside of the contours is painted out with a transmissive image is generated on the basis of the information related to the contours.

In masking processed moving image generator 44, performed is processing that generates the masking processed moving image by overlaying the mask image generated by mask image generator 43 on the background image generated by background image generator 41. In the present exemplary embodiment, a transmissive blue mask image, for example, is overlaid on the background image, and the background image is seen therethrough in the masking processed moving image (refer to FIG. 3A and FIG. 3B).

Next, the monitoring screen displayed on monitor 7 illustrated in FIG. 4 will be described. FIG. 6 is a descriptive diagram illustrating the monitoring screen displayed on monitor 7.

The monitoring screen is browsed by a user in order to recognize activities of a customer in the store. Store selector 51, start button 52, setting button 53, operation mode selector 54, date and time display 55, date and time setting button 56, moving image manipulator 57, moving image display 58, heat map display 59, and display time manipulator 60 are disposed in the monitoring screen.

A user selects a store with a pull-down menu in store selector 51. Start button 52 causes a monitoring process to be started in PC 3. Setting button 53 sets various conditions for the monitoring process. In the present exemplary embodiment, the menu screen (refer to FIG. 10) is displayed as a pop-up if setting button 53 is manipulated. Operation mode selector 54 selects an operation mode. Shop monitoring, product monitoring, a showcase alert, a stock-out alert, and the like are prepared as the operation mode, and selecting the shop monitoring displays the monitoring screen.

Date and time display 55 displays a date and a time, and date and time setting button 56 sets a date and a time. If date and time setting button 56 is manipulated, a date and time setting screen, not illustrated, is displayed, and selecting a date and a time therein displays the selected date and time on date and time display 55 and displays the moving image at the selected date and time on moving image display 58.

A moving image output from camera 1 is displayed as a video on moving image display 58. In the present exemplary embodiment, either the masking processed moving image or the unprocessed moving image is displayed on moving image display 58 according to the output mode of moving image outputter 24 (refer to FIG. 4) in camera 1. FIG. 6 illustrates a case in the first output mode. While the masking processed moving image is displayed on moving image display 58, the unprocessed moving image illustrated in FIG. 3A is displayed on moving image display 58 if the first output mode is switched to the second output mode. While the masking processed moving image or the unprocessed moving image displayed on moving image display 58 is configured as one screen, other imaged moving images having different imaging ranges can also be displayed. In this case, for example, a list of thumbnails of each shop is displayed along with the start of the shop monitoring, and selecting a desired shop allows an imaged moving image of the shop to be displayed. Moving images of a plurality of shops can also be displayed in multiple screens by setting manipulation related to moving image display 58.

Moving image manipulator 57 performs operation related to reproduction of a moving image displayed on moving image display 58. Various manipulation buttons are disposed therein for normal reproduction, fast-forwarding, rewinding, and stopping, and manipulating these manipulation buttons allows efficient browsing of a long duration moving image.

Display time manipulator 60 adjusts the display time of a moving image displayed on moving image display 58. Manipulating display time manipulator 60 allows switching to a moving image at a desired time. Specifically, if slider 61 is moved by using input device 6 such as a mouse, a moving image at the time indicated by slider 61 is displayed on moving image display 58.

The heat map image (heat map bar) generated by heat map image generator 32 (refer to FIG. 4) of PC 3 is displayed on heat map display 59. The heat map image displays the statistical information related to the situation of staying of a person, specifically, a degree of staying (number of persons staying), that is, a temporal trend in the number of persons staying in the monitored area. In the heat map image, the magnitude of a numerical value of the statistical information is represented by changing the display elements (properties of the image) and, specifically, represented by changing color (hue, shade, or the like). Particularly, in the example illustrated in FIG. 6, the degree of staying (number of persons staying) is represented by shades of color. The color is dark as the degree of staying is higher.

A user can recognize a temporal trend in the degree of staying, that is, how many persons are staying in the shop in each time slot, with the heat map image, and the heat map image can be used either for the purpose of monitoring for crime prevention or protection against disaster or for the purpose other than monitoring such as marketing analysis.

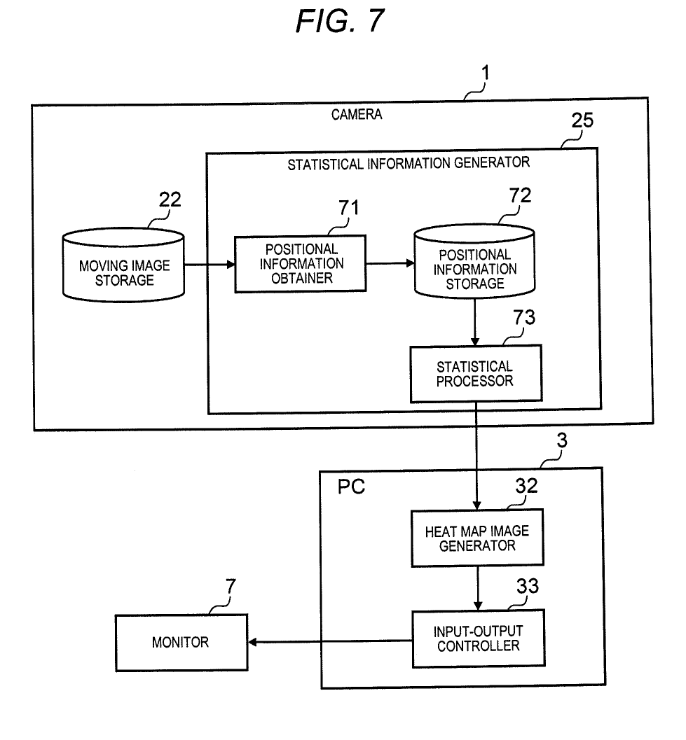

Next, processing of generating the heat map image displayed on the monitoring screen illustrated in FIG. 6 will be described. FIG. 7 is a functional block diagram of a main portion related to processing of generating the heat map image.

In the present exemplary embodiment, the statistical information related to the situation of a person staying in the monitored area is generated in statistical information generator 25 disposed in camera 1, and the heat map image in which the statistical information generated by statistical information generator 25 is visualized is generated in heat map image generator 32 disposed in PC 3.

Statistical information generator 25 of camera 1 includes positional information obtainer 71, positional information storage 72, and statistical processor 73.

Positional information obtainer 71 obtains a moving image from moving image storage 22 and performs processing that obtains positional information for each person appearing in the moving image (frame). In the present exemplary embodiment, a line of motion is obtained for each person as the positional information for each person. Information related to the line of motion for each person obtained by positional information obtainer 71 is stored in positional information storage 72. The positional information obtained by positional information obtainer 71 includes time period information related to a detection time or the like obtained for each person from the time of imaging of the moving image in which a person is detected. The processing performed by positional information obtainer 71 may use a known image recognition technology.

In statistical processor 73, performed is processing that obtains the statistical information related to the situation of staying of a person by performing a temporal statistical process on the positional information (line of motion information) for each person stored in positional information storage 72. In the present exemplary embodiment, the degree of staying (number of persons staying), that is, the number of persons staying in a target area, is obtained as the statistical information. In the processing of obtaining the degree of staying, the degree of staying in a target period is obtained by counting the number of lines of motion passing through the target area in the target period.

As such, if the statistical information is generated in statistical information generator 25 of camera 1, the statistical information is transmitted from camera 1 to PC 3. The processing of generating the heat map image in which the statistical information (degree of staying) is visualized is performed in heat map image generator 32 of PC 3, and display information related to the monitoring screen in which the heat map image is displayed is generated in input-output controller 33.

While the heat map image related to the degree of staying is displayed by obtaining the degree of staying as the statistical information in statistical information generator 25 in the present exemplary embodiment, the heat map image related to the period of time of staying may be displayed by obtaining the period of time of staying, that is, the period of time during which a person stays in the target area. Furthermore, the heat map image related to the degree of staying and the heat map image related to the period of time of staying may be linearly displayed by obtaining both of the degree of staying and the period of time of staying.

If the period of time of staying is obtained as the statistical information, first, the period of time of staying in the target area may be obtained for each person from a time of staying for each person in the target period (a time of entering and a time of leaving with respect to the target area), and next, the period of time of staying may be obtained by an appropriate statistical process such as averaging from the period of time of staying for each person.

Next, manipulation for changing the output mode will be described. FIG. 8 is a descriptive diagram illustrating a screen displayed on monitor 7 when the output mode is changed.

The output mode change screen is displayed on monitor 7 if manipulation that selects the shop monitoring is performed by operation mode selector 54 in the monitoring screen (refer to FIG. 6). In the output mode change screen, a user selects whether to perform output mode changing for switching to the second output mode in which the unprocessed moving image is output. If a YES button is manipulated in the output mode change screen, the user authentication screen is displayed on monitor 7. A user inputs a user ID and a password in the user authentication screen. If a confirm button is manipulated after a user ID and a password are input in the user authentication screen, user authentication is performed in user authenticator 27 (refer to FIG. 4). If user authentication succeeds, the output mode is switched to the second output mode, and the unprocessed moving image is displayed on the monitoring screen. Meanwhile, if a NO button is selected in the output mode change screen, the masking processed moving image is displayed on the monitoring screen.

If a user provides an instruction to switch to the second output mode with a switch that is an output mode changing switch disposed in camera 1, the user authentication screen may be displayed on monitor 7 when manipulation that opens the monitoring screen by launching a monitoring application is performed in PC 3.

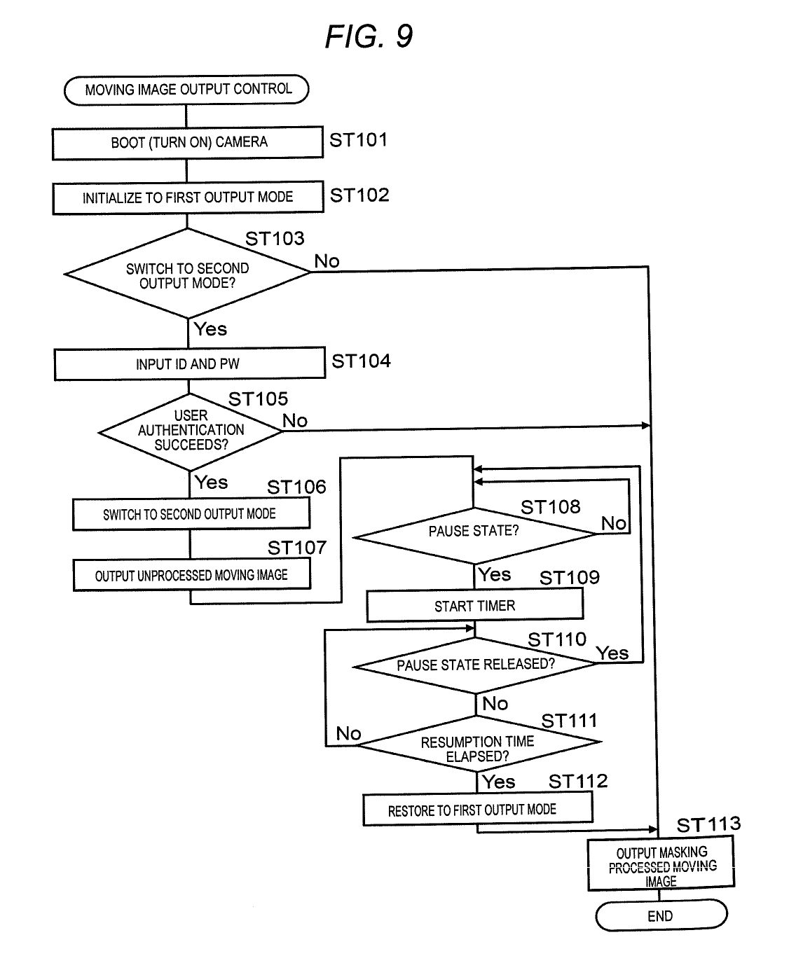

Next, a moving image output control procedure performed by controller 26 of camera 1 illustrated in FIG. 4 will be described. FIG. 9 is a flowchart illustrating the moving image output control procedure performed by controller 26 of camera 1.

If camera 1 is booted, that is, if power is supplied to camera 1 (ST101), output mode initialization that sets the output mode to the first output mode in which the masking processed moving image is output is performed in controller 26 of camera 1 (ST102).

Next, the output mode change screen (refer to FIG. 8) is displayed on monitor 7. In the output mode change screen, if a user selects output mode changing for switching to the second output mode in which the unprocessed moving image is output (YES in ST103), the user authentication screen (refer to FIG. 8) is displayed on monitor 7, and the user inputs a user ID and a password in the user authentication screen (ST104). Then, if user authentication succeeds in user authenticator 27 (YES in ST105), a control that switches the moving image outputter 24 to the second output mode is performed (ST106), and the unprocessed moving image is output from moving image outputter 24 (ST107).

Meanwhile, if the user does not select output mode changing for switching to the second output mode in the output mode change screen (refer to FIG. 8) (NO in ST103) or if user authentication fails (NO in ST105), the first output mode of moving image outputter 24 remains unchanged, and the masking processed moving image is output from moving image outputter 24 (ST113).

If moving image outputter 24 falls into the pause state where moving image output is not performed with no moving image output request from PC 3 (YES in ST108) after switching moving image outputter 24 to the second output mode (ST106) and outputting the unprocessed moving image (ST107), timer 28 starts measuring the period of elapsed time (ST109). If the period of elapsed time measured by timer 28 reaches the predetermined resumption time (YES in ST111) while the pause state is not released (YES in ST110), moving image outputter 24 is restored to the first output mode (ST112). Accordingly, if there is a subsequent moving image output request from PC 3, the masking processed moving image is output from moving image outputter 24 (ST113).

Next, manipulation that sets the authentication information (user ID and password) and the resumption time will be described. FIG. 10 is a descriptive diagram illustrating the menu screen displayed on monitor 7 when the authentication information and the resumption time are set. FIG. 11 is a descriptive diagram illustrating the authentication information setting screen displayed on monitor 7. FIG. 12 is a descriptive diagram illustrating the resumption time setting screen displayed on monitor 7.

A main menu screen is displayed on monitor 7 if the setting button 53 of the monitoring screen (refer to FIG. 6) is manipulated. The main menu screen displays various setting items such as moving image output management and heat map setting, and a user selects one of the setting items. If the moving image output management is selected in the main menu screen, a moving image output management menu screen is displayed on monitor 7. The moving image output management menu screen displays various setting items such as user ID and password setting and resumption time setting, and a user selects one of the setting items.

If the heat map setting is selected in the main menu screen, a screen in which various conditions (target period and the like) for generating the heat map image are set is displayed on monitor 7.

If the user ID and password setting is selected in the moving image output management menu screen, the authentication information setting screen illustrated in FIG. 11 is displayed on monitor 7. A user changes the authentication information (a set of a user ID and a password) in the authentication information setting screen. The authentication information is updated in user authenticator 27 (refer to FIG. 4) if new authentication information is input in the authentication information setting screen.

FIG. 11 illustrates a case where a default setting content (user ID: ADMIN and password: 0000) is changed. An administrator can set an arbitrary user ID and password. Guidance that prompts changing the authentication information may be displayed at the time of installation of camera 1. In addition, permission to browse the unprocessed moving image may be granted to a plurality of users by enabling setting of a plurality of sets of a user ID and a password.

The resumption time setting screen illustrated in FIG. 12 is displayed on monitor 7 if the resumption time setting is selected in the moving image output management menu screen illustrated in FIG. 10. A user inputs the resumption time used by timer 28 in the resumption time setting screen. In the example illustrated in FIG. 12, a numerical value representing the resumption time can be input, and the resumption time can be set to an arbitrary period of time. If the resumption time is input in the resumption time setting screen, processing that sets the resumption time in the resumption time setter 29 (refer to FIG. 4) is performed.

As such, in the present exemplary embodiment, there is a significant risk of leakage of the unprocessed moving image on which the masking process is not performed because camera 1 is connected to a network. However, the risk of leakage of the unprocessed moving image can be reduced because output mode initialization that sets the output mode of moving image outputter 24 to the first output mode, in which the masking processed moving image on which the masking process is performed is output, is performed in controller 26 of camera 1 at the booting of the device.

In addition, in the present exemplary embodiment, user authentication that checks if a person trying to browse a moving image in PC 3 is the user who has permission to browse the unprocessed moving image is performed in user authenticator 27 of camera 1, and controller 26 performs a control that switches the moving image outputter 24 to the second output mode in which the unprocessed moving image is output only if user authentication succeeds. Thus, only the user who has permission to browse the unprocessed moving image can switch the output mode to the second output mode, and the output mode is not easily changed to the second output mode. Therefore, the risk of leakage of the unprocessed moving image can be further reduced.

In addition, in the present exemplary embodiment, controller 26 of camera 1 performs a control that restores moving image outputter 24 to the first output mode if the period of time elapsing from the point in time of a transition into the pause state where moving image output to PC 3 is not performed reaches the predetermined resumption time after moving image outputter 24 is switched to the second output mode. Thus, long-term presence of the second output mode in which the unprocessed moving image is output can be avoided, and the risk of leakage of the unprocessed moving image can be further reduced.

In addition, in the present exemplary embodiment, the statistical information for generating the heat map image displayed on the monitoring screen (refer to FIG. 6) is generated by statistical information generator 25 of camera 1. Accordingly, a moving image that is the source of the statistical information is not required to be output from camera 1, and from this viewpoint, the risk of leakage of the unprocessed moving image can be reduced.

### Second Exemplary Embodiment

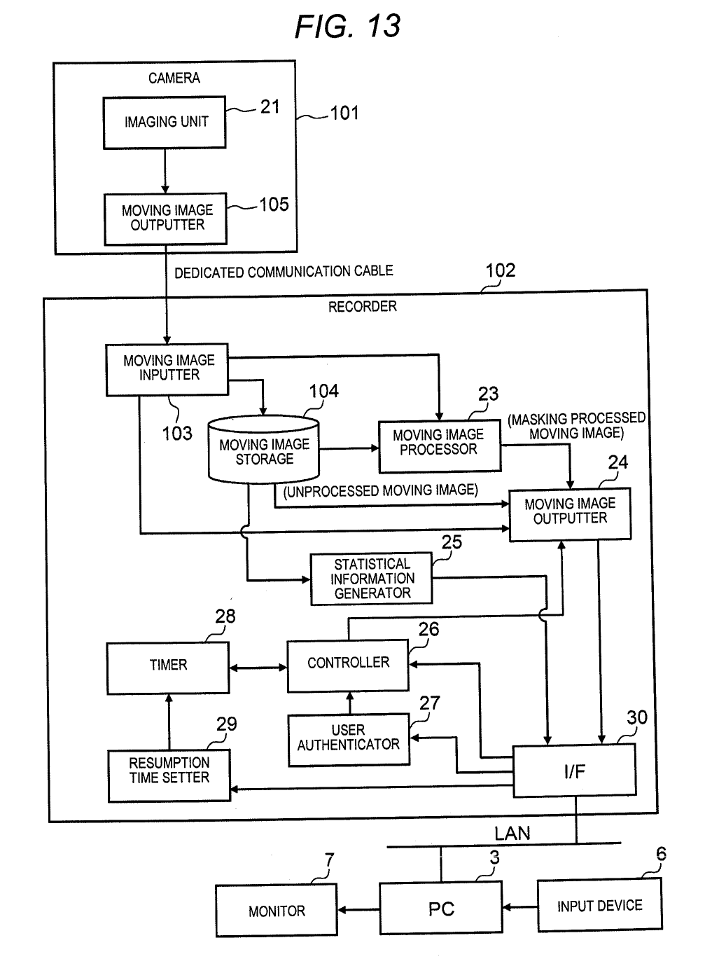

Next, a monitoring system according to a second exemplary embodiment will be described. All those not particularly referred hereto are the same as in the first exemplary embodiment. FIG. 13 is a functional block diagram illustrating a schematic configuration of camera 101 and recorder 102 in the second exemplary embodiment.

While camera 1 is a network connectable so-called network camera (IP camera) in the first exemplary embodiment (refer to FIG. 4), camera 101 is connected to recorder 102 through a dedicated communication cable (for example, a coaxial cable) in the second exemplary embodiment. Recorder (recording device) 102 is configured to be network connectable and is connected to PC 3 through the LAN installed in the store.

In the second exemplary embodiment, moving image processor 23, moving image outputter 24, statistical information generator 25, controller 26, user authenticator 27, timer 28, and resumption time setter 29, which are disposed in camera 1 in the first exemplary embodiment, are disposed in recorder 102. In camera 101, a moving image output from imaging unit 21 is output from moving image outputter 105 to recorder 102 without a change. In recorder 102, the moving image input from camera 1 is input into moving image storage 104 and moving image processor 23 through moving image inputter 103.

Each unit of recorder 102 performs the same processing as in the first exemplary embodiment, and either the masking processed moving image or the unprocessed moving image is output from recorder 102 to PC 3. A memory device of a large capacity such as a hard disk drive is employed as moving image storage 104, and a moving image is stored for a long period.

As such, in the present exemplary embodiment, camera 101 is connected to recorder 102 through a dedicated communication cable, and camera 101 is not directly connected to a network. Thus, the risk of leakage of the unprocessed moving image from camera 101 can be reduced. In addition, recorder 102 connected to camera 101 is set into a state where the masking processed moving image is output by output mode initialization performed at the booting of the device. Thus, the risk of leakage of the unprocessed moving image from recorder 102 can be reduced.

### Third Exemplary Embodiment

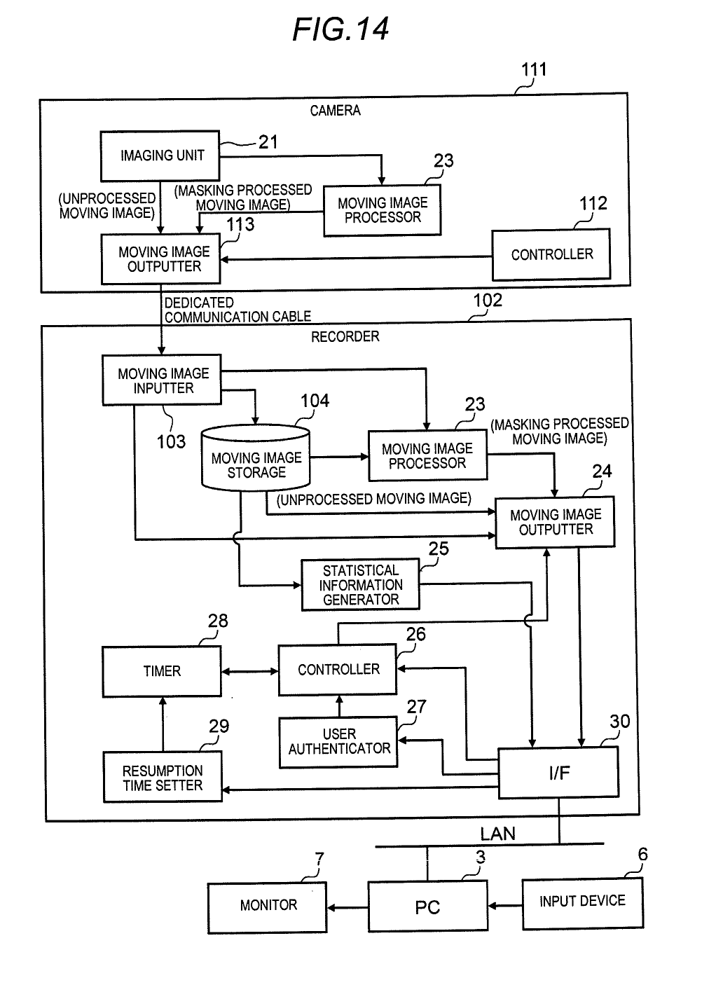

Next, a monitoring system according to a third exemplary embodiment will be described. All those not particularly referred hereto are the same as in the first exemplary embodiment. FIG. 14 is a functional block diagram illustrating a schematic configuration of camera 111 and recorder 102 in the third exemplary embodiment.

While camera 111 includes moving image processor 23 as in the first exemplary embodiment, moving image storage 22 that is disposed in camera 1 (refer to FIG. 4) in the first exemplary embodiment is not provided in the third exemplary embodiment. In addition, in the third exemplary embodiment, camera 111 is connected to recorder 102 through a dedicated communication cable (for example, a coaxial cable) as in the second exemplary embodiment.

In the third exemplary embodiment, in camera 111, the masking processed moving image that results from moving image processor 23 performing the masking process on a moving image output from imaging unit 21 and the unprocessed moving image on which the masking process is not performed are output from moving image outputter 24 in real time. Therefore, if a current moving image is browsed in real time in PC 3, either the masking processed moving image or the unprocessed moving image that is input from camera 111 to recorder 102 may be output from recorder 102 to PC 3 without a change.

Recorder 102 is the same as that in the second exemplary embodiment, and a moving image output from camera 111 is stored in moving image storage 104. While the masking processed moving image and the unprocessed moving image output from camera 111 can be stored together in moving image storage 104, the capacity of moving image storage 104 can be saved by storing only the unprocessed moving image output from camera 111 in moving image storage 104 and performing the masking process with moving image processor 23 of recorder 102 when the masking processed moving image is output in the first output mode.

Camera 111 may be configured to be capable of outputting two types of moving images by outputting each of the masking processed moving image and the unprocessed moving image so that the masking processed moving image and the unprocessed moving image can be simultaneously output. In addition, an output mode changing switch may be disposed in camera 111, and the output mode of moving image outputter 113 may be switched in controller 112 on the basis of a signal of the switch.

As such, in the present exemplary embodiment, camera 111 is connected to recorder 102 through a dedicated communication cable, and camera 111 is not directly connected to a network as in the second exemplary embodiment. Thus, the risk of leakage of the unprocessed moving image from camera 111 can be reduced. In addition, since camera 111 includes moving image processor 23, the masking processed moving image and the unprocessed moving image can be output in real time from camera 111. Thus, processing of recorder 102 can be simplified in a mode where a moving image of the inside of the store is displayed in real time.

### Fourth Exemplary Embodiment

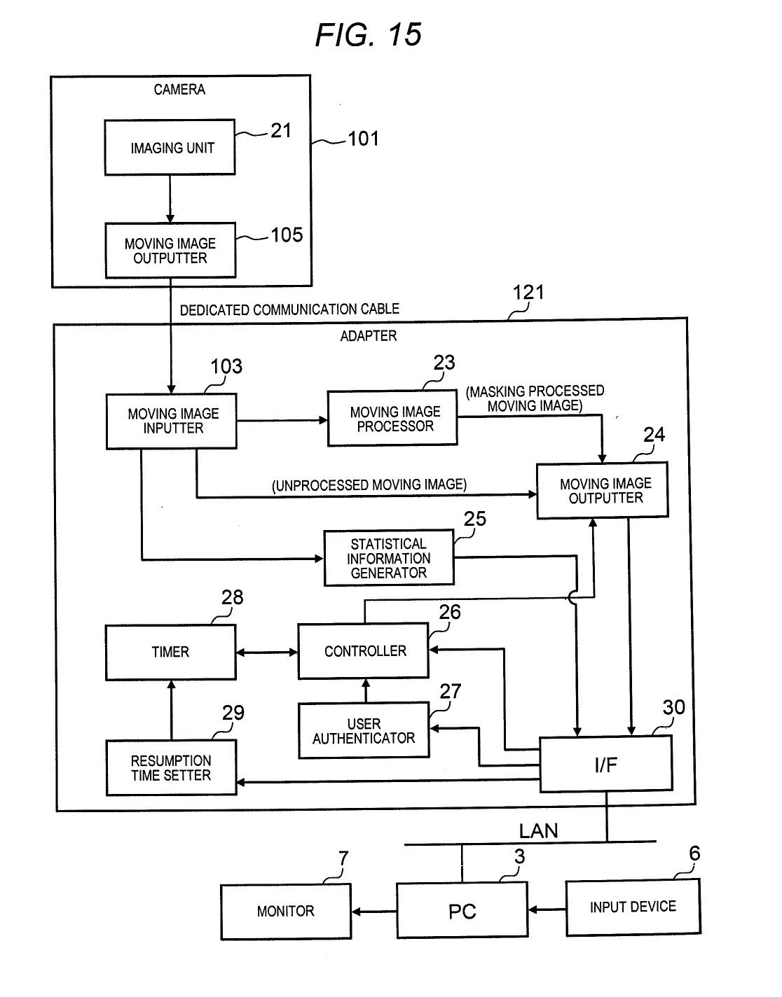

Next, a monitoring system according to a fourth exemplary embodiment will be described. All those not particularly referred hereto are the same as in the first exemplary embodiment. FIG. 15 is a functional block diagram illustrating a schematic configuration of adapter 121 in the fourth exemplary embodiment.

In the fourth exemplary embodiment, adapter (moving image output control device) 121 that is connected to camera 101 and controls moving image output to PC 3 is interposed between camera 101 and PC 3. Camera 101 and adapter 121 are connected through a dedicated communication cable, and adapter 121 and PC 3 are connected through the LAN.

Adapter 121 results from removing moving image storage 104 from recorder 102 (refer to FIG. 13) in the second exemplary embodiment and functions as a network converter that connects camera 101 having a configuration that outputs a moving image through a dedicated communication cable to a network. Each unit of adapter 121 performs the same processing as in the second exemplary embodiment, and either the masking processed moving image or the unprocessed moving image is output from adapter 121 to PC 3. Moving image storage 22, which is a memory device such as a memory card, a hard disk drive, and a solid state drive disposed in camera 1 in the first exemplary embodiment, may be incorporated into adapter 121, and the most recent moving image may be stored within the range of the memory capacity.

As such, in the present exemplary embodiment, camera 101 is connected to adapter 121 through a dedicated communication cable, and camera 101 is not directly connected to a network. Thus, the risk of leakage of the unprocessed moving image from camera 101 can be reduced. In addition, adapter 121 connected to camera 101 is set into a state where the masking processed moving image is output by output mode initialization performed at the booting of the device. Thus, the risk of leakage of the unprocessed moving image from adapter 121 can be reduced.

While camera 101 is configured to output a moving image output from imaging unit 21 to adapter 121 without a change in the present exemplary embodiment, camera 111 that includes moving image processor 23 in the third exemplary embodiment may be connected to adapter 121 in the present exemplary embodiment.

While the present invention is described heretofore on the basis of specific exemplary embodiments, the exemplary embodiments are for illustrative purposes only, and the present invention is not limited to the exemplary embodiments. In addition, all the constituents of the imaging device, the recording device, and the moving image output control device illustrated in the exemplary embodiments according to the present invention are not necessarily essential and may be appropriately selected to the extent, at least, not departing from the scope of the present invention.

For example, while the exemplary embodiments are illustrated by a retail store such as a convenience store, the present invention is not limited to such a retail store and can be applied to a store in the form of business other than a retail store such as a restaurant or a bank. Furthermore, the present invention can be applied for the purpose of targeting a monitored area other than a store.

While camera 1 is configured as an omnidirectional camera that has an imaging range of 360 degrees using a fisheye lens as illustrated in FIG. 2 in the exemplary embodiments, a camera having a predetermined angle of view, a so-called box camera, can also be used.

While the exemplary embodiments are described in an example where PC 3 of the store connected to camera 1, recorder 102, and adapter 121 through the LAN installed in the store is configured as a browsing apparatus that browses the moving image of the inside of the store, PC 11 of the head office may be connected to camera 1, recorder 102, and adapter 121 through a network outside of the store, that is, a wide area network such as a WAN as illustrated in FIG. 1, and PC 11 of the head office may be configured as the browsing apparatus. Furthermore, a mobile terminal such as smartphone 13 or tablet terminal 14 may be configured as the browsing apparatus, in which case the moving image of the inside of the store can be browsed at an arbitrary location such as outside of the store or the head office.

While heat map image generator 32 or input-output controller 33 constituting a GUI is disposed in PC 3, a browsing apparatus, in the exemplary embodiments, the heat map image generator or the input-output controller can be disposed in the camera, the recorder, or the adapter. Furthermore, the heat map image generator or the input-output controller may be disposed in cloud computer 12 that constitutes a cloud computing system as illustrated in FIG. 1. In this case, a necessary screen may be displayed on a monitor by using a web browser in the browsing apparatus such as PC 3.

While user authentication is performed by causing a user to input a set of a user ID and a password in the exemplary embodiments, user authentication may be performed with only a password. In addition, user authentication can employ various known user authentication methods, for example, card authentication performed with an IC card such as a staff card or biometrics authentication such as fingerprint authentication.

While the masking process that changes the inside of the contours of a person to the mask image is performed on an imaged moving image in moving image processor 23 in order to protect the privacy of a customer in the exemplary embodiments, the privacy of a person may be protected by moving image processing different from the masking process. For example, the privacy of a person may be protected by using a secret sharing technique.

Specifically, a low-frequency moving image resulting from extracting a low-frequency component of a spatial frequency from an imaged moving image and a difference moving image that is the difference between the imaged moving image and the low-frequency moving image are generated in the moving image processor of the camera. Then, only the low-frequency moving image is output from the camera to the browsing apparatus such as a PC, and the difference moving image is stored in the recorder. The difference moving image is output from the recorder to the browsing apparatus only if user authentication succeeds via access from the browsing apparatus to the recorder. The original imaged moving image can be restored by combining the low-frequency moving image and the difference moving image in the browsing apparatus. Accordingly, only the user who has permission to browse can browse the original imaged moving image.

The low-frequency moving image does not include information related to a detailed part such as contours represented by a high-frequency component. The low-frequency moving image is a moving image in which the focus is blurred or a mosaic is applied. Thus, while the situation of the monitored area can be roughly recognized in the low-frequency moving image, the situation of the monitored area cannot be checked in detail. Therefore, the privacy of a customer can be protected.

The low-frequency moving image may result from extracting a low-frequency component from only the image region of a person as a target in addition to extracting a low-frequency component from the entire moving image as a target. While moving image processing that protects the privacy of a person is performed by the moving image processor of the camera, such moving image processing may be performed by the recorder or the adapter.

In recent years, there has been developed a 4K television or the like as a monitor in pursuance of high image quality. Employing a camera that supports such a 4K television allows an increase in the capability of identifying a person and allows a user to easily recognize activities of a person from a reproduced masked moving image even under an environment in which there exist many persons.

### INDUSTRIAL APPLICABILITY

The imaging device, the recording device, and the moving image output control device according to the present invention have the effect that the risk of leakage of the unprocessed moving image on which the masking process is not performed can be reduced and are useful as an imaging device that images the monitored area and outputs the moving image thereof to a browsing apparatus, a recording device that stores a moving image output from the imaging device and outputs the moving image to the browsing apparatus, and a moving image output control device that is connected to the imaging device and controls moving image output to the browsing apparatus.

### REFERENCE SIGN LIST

1 CAMERA (IMAGING DEVICE)

2 RECORDER

3 PC (BROWSING APPARATUS)

6 INPUT DEVICE

7 MONITOR

11 PC

13 SMARTPHONE

14 TABLET TERMINAL

21 IMAGING UNIT

22 MOVING IMAGE STORAGE

23 MOVING IMAGE PROCESSOR

24 MOVING IMAGE OUTPUTTER

26 CONTROLLER

27 USER AUTHENTICATOR

28 TIMER

29 RESUMPTION TIME SETTER

102 RECORDER (RECORDING DEVICE)

111 CAMERA (IMAGING DEVICE)

121 ADAPTER (MOVING IMAGE OUTPUT CONTROL DEVICE)

1. An imaging device that images a monitored area and outputs a moving image thereof to a browsing apparatus, the imaging device comprising:
a moving image processor that performs a masking process of changing the inside of contours of a person to a mask image on the moving image;
a moving image outputter that outputs a masking processed moving image on which the masking process is performed in a first output mode and outputs an unprocessed moving image on which the masking process is not performed in a second output mode; and
a controller that switches the output mode of the moving image outputter according to an instruction of a user,
wherein the controller performs output mode initialization that sets the output mode to the first output mode at a booting of the device.

2. The imaging device of claim 1, further comprising:
a user authenticator that retains authentication information related to a user having permission to browse the unprocessed moving image and performs user authentication by comparing input information input by the user in the browsing apparatus with the authentication information,
wherein the controller performs a control that switches the moving image outputter to the second output mode only if user authentication succeeds in the user authenticator.

3. The imaging device of claim 2,
wherein the authentication information is a password.

4. The imaging device of claim 2,
wherein the authentication information is a set of a user ID and a password.

5. The imaging device of claim 2,
wherein the controller performs a control that restores the moving image outputter to the first output mode if the period of time elapsing from the point in time of a transition into a pause state where moving image output to the browsing apparatus is not performed reaches a predetermined resumption time after the moving image outputter is switched to the second output mode.

6. The imaging device of claim 5, further comprising:
a resumption time setter that sets the resumption time according to a manipulation input of a user inputting an arbitrary period of time.

7. A recording device that stores a moving image output from an imaging device and outputs the moving image to a browsing apparatus, the recording device comprising:
a moving image storage that stores a moving image input from the imaging device;
a moving image processor that performs a masking process of changing the inside of contours of a person to a mask image on the moving image stored in the moving image storage;
a moving image outputter that outputs a masking processed moving image on which the masking process is performed in a first output mode and outputs an unprocessed moving image on which the masking process is not performed in a second output mode; and
a controller that switches the output mode of the moving image outputter according to an instruction of a user,
wherein the controller performs output mode initialization that sets the output mode to the first output mode at a booting of the device.

8. A moving image output control device that is connected to an imaging device and controls moving image output to a browsing apparatus, the moving image output control device comprising:
a moving image processor that performs a masking process of changing the inside of contours of a person to a mask image on a moving image input from the imaging device;
a moving image outputter that outputs a masking processed moving image on which the masking process is performed in a first output mode and outputs an unprocessed moving image on which the masking process is not performed in a second output mode; and
a controller that switches the output mode of the moving image outputter according to an instruction of a user,
wherein the controller performs output mode initialization that sets the output mode to the first output mode at a booting of the device.
